(19) United States
(12) Patent Application Publication
(10) Pub. No.: US 2009/0162712 A1
(43) Pub. Date: Jun. 25, 2009

(54) FUEL CELL

(75) Inventors: Ryosuke YAGI, Yokohama-shi (JP); Yuusuke Sato, Tokyo (JP); Yoshihiro Akasaka, Kawasaki-shi (JP); Norihiro Tomimatsu, Tokyo (JP); Naomi Shida, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/342,268

(22) Filed: Dec. 23, 2008

(30) Foreign Application Priority Data
Dec. 25, 2007 (JP) P2007-333004

(51) Int. Cl. H01M 8/04; H01M 8/10

(52) U.S. Cl. 429/24; 429/30

(57) ABSTRACT

According to an aspect of the present invention, there is provided a fuel cell including: a membrane electrode assembly including: an electrolyte membrane; anode and cathode catalyst layers respectively disposed on the electrolyte membrane; and anode and cathode gas diffusion layers respectively disposed on the anode and cathode catalyst layers; a cathode porous body including a front face portion and a rear face portion and being disposed on the cathode gas diffusion layer at the front face portion, the front face portion having an electric conductivity higher than that of air and having a hydrophilicity higher than that of the rear face portion; an anode passage plate disposed on the anode gas diffusion layer; and an air supply apparatus that supplies air toward an end of the cathode porous body.

### CROSS-REFERENCE TO RELATED APPLICATIONS

This application claims priority from Japanese Patent Application No. 2007-333004 filed on Dec. 25, 2007, the entire contents of which are incorporated herein by reference.

### BACKGROUND OF THE INVENTION

1. Field of the Invention

An aspect of the present invention relates to a fuel cell, and more particularly, to a solid polymer fuel cell.

2. Description of the Related Art

A solid polymer fuel cell characterized to have high output density is known as a kind of fuel cell. To stably operate this kind of solid polymer fuel cell, it is important to control the temperature and humidity of the power generating section thereof.

Particularly, a humidity control on the cathode side of the fuel cell is important. On the cathode side, water is present since water is generated by a cathode reaction and since water is transferred from the anode side to the cathode side through the electrolyte membrane of the fuel cell. If such the cathode-side water is not completely discharged to the outside and is accumulated inside the cathode gas diffusion layer, it is difficult to supply air required to the cathode reaction thereto, and the power generation efficiency of the entire fuel cell lowers. In particular, air supply is difficult in the region directly below the convex section of the cathode passage plate making contact with the cathode gas diffusion layer in comparison with the region of the concave section directly below the opening of the collection plate on the cathode side. Hence, water is likely to be accumulated and air supply is likely to be inhibited.

A fuel cell in which a holder for holding reaction products is disposed in the oxidant gas passage of the positive electrode is proposed (JP-A 2003-157879).

In such fuel cell, although water can be removed from the portion in which the holder is disposed, water cannot be removed appropriately from the other portions. As a result, there are present a high power generation efficiency region and a low power generation efficiency region inside the face of one electrode, and the overall power generation efficiency cannot be increased. In addition, since a current density variation is induced during the operation, long-term reliability becomes a problem.

Another fuel cell in which a cathode porous body having water repellency and electric conductivity is disposed so as to be joined to or made contact with a membrane electrode assembly to provide a pressure variation inside the contact face, thereby accelerating a water transfer from the high-pressure region to the low-pressure region and preventing water from being accumulated inside the porous body, is proposed (JP-A 2007-077839).

However, in such fuel cell, since liquid is passed through the cross-section of the cathode porous body, processing for discharging water from the entire interior of the porous body is required, and electric conductivity and mechanical strength are decreased.

Still another fuel cell in which heat generated from the fuel cell elements is radiated to the outside via a low thermal-resistance heat conductor, such as a porous body, is proposed (JP-A 2004-031096, for example, paragraph [0072]).

However, in such fuel cell, since water in the porous body is not controlled and not removed appropriately, the above-mentioned power generation efficiency reduction is inevitable.

As a fuel cell system in which temperature and humidity are controlled to be maintained within appropriate ranges for power generation, still another fuel cell in which an air supply apparatus and a cooling apparatus are independently controlled is proposed.

If a single fan is used for drying and cooling the fuel cell and if the fan is operated in a low-temperature high-humidity condition, not only the humidity but also the temperature lowers, and power generation efficiency lowers. Therefore, in the above-mentioned fuel cell, an independent fan is provided to supply air to the fuel cell (JP-A2004-192974, for example, paragraph [0006]).

However, when multiple fans are provided, the system becomes volume becomes large and it requires high power consumption.

As described above, in the related-art fuel cells, control of humidity and temperature cannot be performed easily.

### SUMMARY OF THE INVENTION

According to an aspect of the present invention, there is provided a fuel cell including: a membrane electrode assembly including: an electrolyte membrane; an anode catalyst layer disposed on one side of the electrolyte membrane; a cathode catalyst layer disposed on the other side of the electrolyte membrane; an anode gas diffusion layer disposed on the anode catalyst layer; and a cathode gas diffusion layer disposed on the cathode catalyst layer; a cathode porous body including a front face portion and a rear face portion, the cathode porous body being disposed on the cathode gas diffusion layer at the front face portion, the front face portion having an electric conductivity higher than that of air and having a hydrophilicity higher than that of the rear face portion; an anode passage plate having a fuel passage and disposed on the anode gas diffusion layer; and an air supply apparatus that supplies air toward an end of the cathode porous body.

### BRIEF DESCRIPTION OF THE DRAWINGS

FIG. 1 is a schematic sectional view showing a power generating stack according to an embodiment of the present invention;

FIG. 2 is a perspective view showing a power generating stack assembly according to the embodiment;

FIGS. 3A and 3B are schematic views showing a cathode porous body according to the embodiment;

FIG. 4 is a schematic sectional view showing a power generating stack according to another embodiment of the present invention;

FIG. 5 is a schematic sectional view showing a power generating stack according to still another embodiment of the present invention;

FIG. 6 is a schematic sectional view showing a power generating stack according to still another embodiment of the present invention;

FIG. 7 is a schematic sectional view showing a power generating stack according to still another embodiment of the present invention;

FIG. 8 is a schematic view showing a fuel cell system according to still another embodiment of the present invention;

FIG. 9 is a graph showing the relationship between temperature and air supply amount according to the embodiments;

FIG. 10 is a graph showing the characteristics of examples of the present invention; and

FIG. 11 is a graph showing the characteristics of examples of the present invention.

### DETAILED DESCRIPTION OF THE EMBODIMENT

Embodiments of the present invention will be described referring to the drawings. In the following descriptions given with reference to the drawings, the same or similar components are designated by the same or similar numerals. However, it should be noted that the drawings are schematic and that relationships between the thicknesses and planar dimensions of the components, the ratios of thicknesses of the respective layers and the like are different from actual ones. Hence, the specific thicknesses and dimensions should be determined in consideration of the following descriptions. Furthermore, it is a matter of course that portions different in dimensional relationship and ratio are included among the respective drawings.

Moreover, the following embodiments merely exemplify apparatuses and methods for embodying the technical concept of the present invention, and the material properties, shapes, structures, arrangements, etc. of the components according to the technical concept of the present invention are not limited to those described below. The technical concept of the present invention can be modified variously within the scope of the claims.

### First Embodiment

A first embodiment of the present invention will be described below referring to the drawings. In the following descriptions, a direct methanol fuel cell (DMFC) in which an aqueous methanol solution is used as fuel is taken as an example and described.

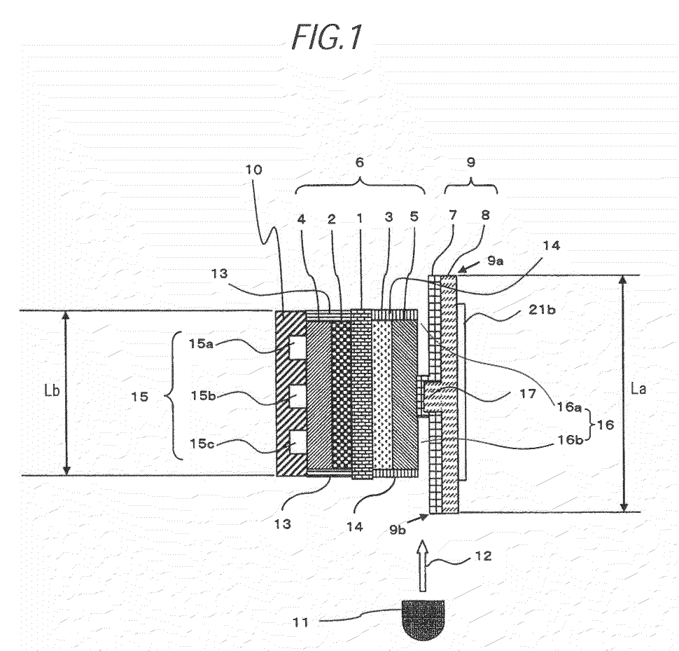

FIG. 1 is a schematic sectional view showing a portion corresponding to one cell element of a power generating stack assembly of a fuel cell according to the first embodiment.

The fuel cell according to this embodiment of the present invention includes a membrane electrode assembly 6 including an electrolyte membrane 1, an anode catalyst layer 2 and a cathode catalyst layer 3 disposed on both sides of the electrolyte membrane 1 respectively, and an anode gas diffusion layer 4 and a cathode gas diffusion layer 5 disposed on the anode catalyst layer 2 and the cathode catalyst layer 3 respectively on the opposite sides of the electrolyte membrane 1; a cathode porous body 9 disposed on the cathode gas diffusion layer 5 on the opposite side of the cathode catalyst layer 3, the front face 7 (front face portion) of which has electric conductivity higher than that of air, makes contact with the cathode gas diffusion layer 5 and has hydrophilicity higher than that of the rear face 8 (rear face portion); an anode passage plate 10 disposed on the anode gas diffusion layer 4 on the opposite side of the anode catalyst layer 2 and having a fuel passage 15; a cathode collection plate 21b disposed on the cathode porous body 9 on the opposite side of the cathode gas diffusion layer 5; and an air supply apparatus 11 for supplying air to the ends 9a and 9b of the cathode porous body 9.

In FIG. 1, the air supply apparatus 11 is shown so as to supply air 12 from downward to upward on the front face of the paper. However, in reality, the air is supplied in a direction orthogonal to the front face of the paper from the front face to the rear face or in the opposite direction.

In addition to these components, anode gaskets 13 and cathode gaskets 14 are provided to suppress the leakage of the fuel and the air 12.

### [Membrane Electrode Assembly]

The membrane electrode assembly 6 includes the electrolyte membrane 1, the anode catalyst layer 2 and the cathode catalyst layer 3 disposed on both sides of the electrolyte membrane 1 respectively, and the anode gas diffusion layer 4 and the cathode gas diffusion layer 5 disposed on the anode catalyst layer 2 and the cathode catalyst layer 3 respectively on the opposite sides of the electrolyte membrane 1.

### [Electrolyte Membrane]

The electrolyte membrane 1 can be formed of, for example, a Nafion membrane™ manufactured by Dupont. The electrolyte membrane 1 functions as a medium for transferring the protons (H⁺) generated in the anode catalyst layer 2 to the cathode catalyst layer 3.

### [Anode Catalyst Layer and Cathode Catalyst Layer]

The anode catalyst layer 2 and the cathode catalyst layer 3 are disposed on both sides of the electrolyte membrane 1 respectively. In the case that an aqueous methanol solution is used as fuel, a Pt—Ru catalyst, for example, can be used for the anode catalyst layer 2. Furthermore, a Pt catalyst can be used for the cathode catalyst layer 3.

The anode catalyst layer can be made by mixing and dispersing the Pt—Ru catalyst with a perfluorosulfonic acid resin solution (Nafion solution™), water and ethylene glycol and then by applying the mixture to the electrolyte membrane 1 using a spraying method.

Furthermore, the cathode catalyst layer can be made by mixing and dispersing the Pt catalyst with a perfluorosulfonic acid resin solution (Nafion solution™), water and ethylene glycol and then by applying the mixture to the electrolyte membrane 1 using a spraying method.

### [Anode Gas Diffusion Layer and Cathode Gas Diffusion Layer]

The anode gas diffusion layer 4 and the cathode gas diffusion layer 5 are disposed on the anode catalyst layer 2 and the cathode catalyst layer 3 respectively on the opposite sides of the electrolyte membrane 1. The anode gas diffusion layer 4 and the cathode gas diffusion layer 5 can be made of carbon paper, carbon cloth, carbon nonwoven cloth, etc. The gas diffusion layers may be provided with a water-repellent high-density carbon layer (microporous layer: MPL) mainly made of carbon powder and PTFE.

The anode gas diffusion layer 4 provides functions for smoothly supplying fuel to the anode catalyst layer 2, discharging products and carrying out power collection. The cathode gas diffusion layer 5 provides functions for smoothly supplying air to the cathode catalyst layer 3, discharging products and carrying out power collection.

### [Method for Stacking Components of Membrane Electrode Assembly]

The membrane electrode assembly 6 is made, for example, by joining the electrolyte membrane 1 both sides of which the anode catalyst layer 2 and the cathode catalyst layer 3 have been applied, to the anode gas diffusion layer 4 and the cathode gas diffusion layer 5. Alternatively, the electrolyte membrane 1 may be joined to the anode gas diffusion layer 4 to which the anode catalyst layer 2 has been applied and also joined to the cathode gas diffusion layer 5 to which the cathode catalyst layer 3 has been applied. The contact resistances at the interfaces where the electrolyte membrane 1 makes contact with the anode catalyst layer 2 and the cathode catalyst layer 3 can be reduced by carried out the joining at high pressure.

“Joining” herein means a processing method to join two members so as to be hardly separated without causing deformation in the members when the separation is attempted using a simple tool, for example, by pressing the two members and causing a fusion at the contacting portions of the members. “Joining” also means a state obtained as the result of execution of the processing method. This definition is also applicable to, for example, the membrane electrode assembly 6. When the components of the membrane electrode assembly 6 are joined to form the membrane electrode assembly 6, the thickness of the obtained membrane electrode assembly 6 over the entire face thereof is smaller than the total thickness of each component. On the other hand, “contact” described later means a state in which two members are not compressed beforehand or integrated but can be separated easily from each other; for example, when the components of the membrane electrode assembly 6 made contact with one another are disassembled, the components can be separated from one another easily. “Contact” is therefore distinguished from “joining.”

### [Cathode Porous Body]

The cathode porous body 9 is disposed on the cathode gas diffusion layer 5 on the opposite side of the cathode catalyst layer 3. The cathode porous body 9 has passages 16a and 16b separated by a passage wall (partition) 17 to guide the air 12 supplied from the air supply apparatus 11 to the membrane electrode assembly 6.

As described below, the cathode porous body 9 can be made of, for example, porous metal, the front face 7 of which is subjected to hydrophilizing processing so that the entire cathode porous body 9 has high electric conductivity and so that the liquid permeability of the front face 7 thereof is higher than that of the rear face 8. In addition to such porous metal, it is also possible to use porous sintered metal and porous carbon.

### (Hydrophilicity)

The front face 7 of the cathode porous body 9 making contact with the cathode gas diffusion layer 5 has hydrophilicity. Hence, the front face 7 can absorb the water discharged from the membrane electrode assembly 6 and transfer the water to the ends 9a and 9b of the cathode porous body 9. In other words, the front face 7 of the cathode porous body 9 has liquid permeability.

The front face 7 of the cathode porous body 9″ herein means the proximity of the front face of the cathode porous body 9. In other words, when it is assumed that the face of the cathode porous body 9 making contact with the cathode gas diffusion layer 5 is “one face” and that the rear face thereof is the “other face,” the “front face” does not mean the entire region in the depth direction ranging from the one face to the other face of the cathode porous body 9 but means a region in the depth direction ranging from the one face partway to the other face of the cathode porous body 9. That is, the “front face” means a volumetric region having a depth. The front face 7 shown in FIG. 1 is a schematic representation of this region.

The thickness of the front face 7 is determined depending on the electric power generation and the area of the membrane electrode assembly 6. For example, in the case that the electric power generation per unit area is large, the amount of the water generated by the cathode reaction described later increases. Hence, the front face 7 is required to have a predetermined thickness to discharge the water. When it is assumed that the amount of water required to be discharged per unit time and unit area is w (cm³/(cm²·s)) and that the porosity of the region of the front face 7 is p (vol %), it is preferable that the thickness t (cm) of the front face 7 should satisfy Formula 1 wherein tₒ (cm) is the average membrane thickness of the cathode porous body 9. The average membrane thickness should be obtained by measuring the values at multiple points (for example, ten points) on the cathode porous body 9 and by obtaining the arithmetic mean thereof.

w/p≦t≦tₒ (Formula 1)

“The front face 7 of the cathode porous body 9 making contact with the cathode gas diffusion layer 5 has hydrophilicity higher than that of the rear face 8 thereof” means that, in the cathode porous body 9, the above-mentioned volumetric region (the front face 7) making contact with the cathode gas diffusion layer 5 has hydrophilicity and the other region (the rear face 8) is inferior in hydrophilicity in comparison with the front face 7. The hydrophilicity of each face of the cathode porous body 9 is evaluated by comparing the water contact angles of the respective faces.

In addition, the hydrophilized state of the cathode porous body 9 can be changed at the partition 17 of the central section and the proximity thereof and at the ends 9a and 9b to improve the capability of discharging water from the membrane electrode assembly 6 through the cathode porous body 9. In the case that the hydrophilicity at the ends 9a and 9b is made higher than the hydrophilicity at the central section, the water located at the partition 17 of the central section and the proximity thereof is easier to move toward the ends 9a and 9b. To change the hydrophilicity, the hydrophilicity of a resin that produces the hydrophilic effect and the additive amount thereof may be changed. In addition, a method for changing the diameter of the pores of the porous body can also be adopted. In the case that the additive amount of the resin having hydrophilicity is made larger at the ends 9a and 9b than that at the partition 17 of the central section and the proximity thereof, the hydrophilicity at the ends 9a and 9b becomes high, and the capillary force at the ends 9a and 9b becomes higher than that at the partition 17 of the central section and the proximity thereof, whereby the water can move toward the ends 9a and 9b. The hydrophilicity can be obtained by measuring the water contact angle value. As the water contact angle is smaller, the hydrophilicity is determined to be higher. Hence, the hydrophilicity can be evaluated by measuring the water contact angles at the partition 17 of the central section and the proximity thereof and at the ends 9a and 9b.

Furthermore, when the resin having hydrophilic property is applied to the porous body, the porosity of the porous body at the partition 17 of the central section and the proximity thereof is changed so as to be different from the porosity of the porous body at the ends 9a and 9b so that the diameter of the pores at the ends 9a and 9b of the porous body is made smaller. As a result, the capillary force at the ends 9a and 9b becomes larger than that at the partition 17 of the central section and the proximity thereof, and water is easier to move toward the ends 9a and 9b.

### (Electric Conductivity)

The electric conductivity of the cathode porous body 9 is made higher than that of air. This is intended to provide a function of supplying electrons (e⁻) used for the cathode reaction (Formula 3) described later from the anode catalyst layer 2 via the anode gas diffusion layer 4, the anode passage plate 10 and an external circuit (not shown) through the cathode collection plate 21b and finally to the cathode gas diffusion layer 5 and the cathode catalyst layer 3.

### (Air Permeability)

The cathode porous body 9 is provided with the passages 16a and 16b for taking in the air 12 from the air supply apparatus 11 (for example, a fan). In a second embodiment, the porosity of the cathode porous body 9 is raised so as to increase the air permeability, thereby surely supplying the air 12 required for power generation. On the other hand, a member such as a metal plate having no porosity and being subjected merely to hydrophilizing processing on its surface cannot be used as the cathode porous body 9. This is because water transfer due to use of the capillary force cannot be utilized for such a member and the effect of the water transfer is hardly obtained. In other words, in order to obtain the effect of transferring water using the capillary force, constant porosity for providing the capillary force with the member to be used is required. The porosity herein means the ratio of the volume occupied by the pores to the unit volume of the cathode porous body 9 and can be measured using the mercury intrusion porosimetry.

### (Passages)

The cathode porous body 9 according to the embodiment has the concave passages 16a and 16b separated by the passage wall (partition) 17 to guide a part of the air 12 supplied from the air supply apparatus 11 to the membrane electrode assembly 6. The structure having the passages 16a and 16b described above is effective in the case that high output density per unit area is required.

The concave shape herein means that the passages 16a and 16b have a dent. In other words, the sectional shape of the passages in a direction orthogonal to the streamline is not limited to a rectangular shape but can take any shapes, provided that it has a structure of allowing fluid to flow, such as a semicircular shape or a semi-elliptical shape.

### TECHNICAL EFFECT

In comparison with the case in which the related-art cathode porous body is provided with liquid permeability mainly in the sectional direction (the left-right direction of the paper surface in FIG. 1), the embodiment cathode porous body 9 is provided with liquid permeability (hydrophilicity) in the proximity of the front face 7 making contact with the cathode gas diffusion layer 5 merely in the face direction thereof, whereby hydrophilizing processing for allowing a liquid such as water to permeate through the cross-section of the cathode porous body 9 is not required. Hence, merely the proximity of the front face 7 of the cathode porous body 9 making contact with the cathode gas diffusion layer 5 should be subjected to hydrophilizing processing. As a result, the cathode porous body 9 can be processed more easily than the related-art cathode porous body 9, and the processing cost is expected to be reduced.

In the related-art cathode porous body, an electric conductivity is reduced since additives such as resins are added to the entire cathode porous body to raise its liquid permeability. However, in the embodiment cathode porous body 9, the range of the depth in which additives such as resins should be added is limited to merely the proximity of the front face, the reduction in the electric conductivity of the cathode porous body 9 can be diminished in comparison with the related-art cathode porous body, and the power generating efficiency can be improved.

Furthermore, in the related-art cathode porous body, since the hydrophilizing processing for allowing a liquid such as water to permeate through the cross-section thereof is performed, the mechanical strength of the entire cathode porous body is decreased. However, in the embodiment, since merely the proximity of the front face 7 making contact with the cathode gas diffusion layer 5 is subjected to the hydrophilizing processing, the mechanical strength of the cathode porous body 9 is not impaired in regions other than the proximity of the front face 7. Hence, the reduction in the mechanical strength can be suppressed as a whole in comparison with the related-art cathode porous body 9.

Since merely the front face 7 of the cathode porous body 9 making contact with the cathode gas diffusion layer 5 is provided with hydrophilicity, the cathode porous body 9 can transfer the water discharged from the membrane electrode assembly 6 through the region of the front face 7 of the cathode porous body 9 to the outside of the membrane electrode assembly 6 while the electric conductivity and mechanical strength thereof are ensured.

### (Shape)

The water discharged from the membrane electrode assembly 6 is absorbed in the front face 7 of the cathode porous body 9 and transferred to the ends 9a and 9b of the cathode porous body 9. The water is then removed from the ends 9a and 9b to the outside of the system of the power generating stack. At this time, the air 12 is supplied from the air supply apparatus 11 to the ends 9a and 9b containing water in the front face 7 and water is vaporized from the ends 9a and 9b. With this structure, both functions and effects of “the removal of water from the ends 9a and 9b” and “the cooling of the cathode porous body 9” can be obtained because the cathode porous body 9 can be cooled using the vaporization heat of water.

The ends 9a and 9b should be exposed to the air 12 supplied from the air supply apparatus 11. Further, in order to effectively utilize the temperature control effect including the cooling effect, it is preferable that at least portions of the ends 9a and 9b of the cathode porous body 9 protrude from the contour of the membrane electrode assembly 6. “Protrusion” herein means that the length (hereafter referred to as La, see FIG. 1) of the cathode porous body 9 is larger than the length (hereafter referred to as Lb, see FIG. 1) of the outside contour of the membrane electrode assembly 6 including the gaskets thereof. The area of the cathode porous body 9 making contact with the air 12 can be made larger by establishing the relationship of La>Lb as described above. With this configuration, the water vaporization at the ends 9a and 9b can be accelerated, and the cooling capability for the entire power generating stack through the cathode porous body 9 can be improved.

With this structure, since the air supply apparatus 11 can be used for both power generation and cooling, special cooling fins are not required, and the fuel cell can be miniaturized and simplified.

### (Operation Method)

When the temperature of the power generating stack including the membrane electrode assembly 6 is higher than a predetermined temperature, the supply amount of the air 12 is increased to enhance water vaporization, whereby the cathode porous body 9 can be cooled. The cathode porous body 9 having been cooled cools the cathode gas diffusion layer 5 making contact therewith, and the cathode gas diffusion layer 5 having been cooled also cools the cathode catalyst layer 3. By carrying out this cooling continuously or intermittently for a predetermined time, the entire power generating stack can be cooled to a temperature within a desired temperature range. When the temperature of the power generating stack is lower than the predetermined temperature, the operation opposite to that described above is carried out, whereby the temperature of the power generating stack can be maintained within the predetermined temperature range. The temperature of the power generating stack can be measured using a thermocouple disposed at any location of the power generating stack. In the embodiment, a thermocouple is inserted into the central section of the anode passage plate 10 to measure the temperature.

Since the above-mentioned porous sintered metal used as the material of this kind of cathode porous body 9 is also excellent in thermal conductivity, it is suited for the above-mentioned temperature control.

Furthermore, water can be discharged continuously from the cathode porous body 9 by connecting a member having high hydrophilicity equal to or higher than that of the front face 7 of the cathode porous body 9 to the ends 9a and 9b in addition to the above-mentioned configuration. This kind of connection member can be made of nonwoven cloth, sponge, paper, etc. Moreover, water can be accumulated by connecting an accumulation section, such as a water recovery tank. It is effective to provide an accumulation section at the ends since the front face 7 of the cathode porous body 9 is required to be maintained in a state of being humid to some extent at all times.

### [Cathode Collection Plate]

The cathode collection plate 21b of the fuel cell according to the embodiment is disposed on the cathode porous body 9 on the opposite side of the cathode gas diffusion layer 5. The cathode collection plate 21b serves to collect electricity from the membrane electrode assembly 6 while the strength required when the power generating stack is stacked into multiple layers is ensured. As the material of the cathode collection plate 21b, titanium can be used for example. Furthermore, materials having high conductivity and high strength, for example, metal materials, such as stainless steel, and high-density carbon, can be used. The cathode collection plate 21b can have any desired shapes, such as a concave or convex shape, in addition to a planar shape.

### [Anode Passage Plate]

The anode passage plate 10 of the fuel cell according to the embodiment is disposed on the anode gas diffusion layer 4 on the opposite side of the anode catalyst layer 2 and has the fuel passage 15. In other words, the passage 15 is provided to supply fuel to the anode catalyst layer 2 through the anode gas diffusion layer 4 and to discharge the products produced according to the anode reaction (Formula 2).

The fuel passage 15 provided in the anode passage plate 10 can be formed as, for example, a serpentine passage or parallel passages formed of multiple passages arranged in parallel.

### [Air Supply Apparatus]

An extrusion fan can be used as the air supply apparatus 11 of the fuel cell according to the embodiment. A suction blower may also be used. The cathode porous body 9 is cooled by the air 12 supplied from the air supply apparatus 11 to the ends 9a and 9b thereof and also cooled by the water vaporization. Furthermore, the air supply apparatus 11 also supplies oxygen required for the cathode reaction (Formula 3) in the membrane electrode assembly 6.

In the case that the air 12 is supplied to the fuel cell using a single fan, that is, in the case that a single fan serves to dry and cool the power generating stack, air blasting is carried out using the fan to lower the humidity while the fuel cell is low in temperature and high in humidity. However, in this case, the effect of lowering the humidity is not obtained remarkably, and merely the temperature lowers, whereby the power generation efficiency lowers. This lowering has mainly two reasons. One is that the flow amount of the cooling air increases as the amount of the air supplied to the membrane electrode assembly 6 increases. The other is that if the amount of the air 12 supplied to the membrane electrode assembly 6 is increased, the amount of the water transferred from the anode to the cathode through the electrolyte membrane 1 increases, whereby a larger amount of water is accumulated in the cathode catalyst layer 3 (for example, refer to JP-A 2007-165148).

However, in the embodiment, the partition 17 is provided at the central section of the cathode porous body 9. Since the pressure required when the air 12 passes through the partition 17 of the cathode porous body 9 is higher than the pressure of the air that can be supplied from the fan, air supply due to convection is suppressed. In other words, since the spaces of the passages 16a and 16b shown in FIG. 1 are separated by the partition 17, even if the pressure difference between the passages 16a and 16b is given by the flow distribution of the air from the air supply apparatus 11, no convection occurs. Hence, the supply of the air 12 to the membrane electrode assembly 6 is carried out owing to the effect of natural diffusion. Hence, even if the flow amount of the air supplied from the fan is increased or decreased to control the cooling of the power generating stack, the flow amount of the air 12 supplied to the membrane electrode assembly 6 is determined independently by the diffusion.

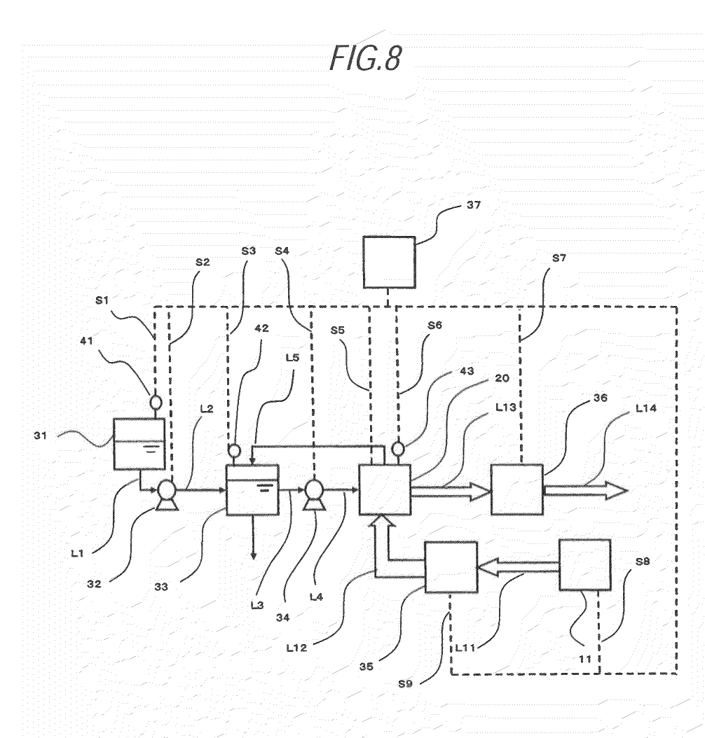

On the other hand, the water discharged from the membrane electrode assembly 6 and transferred to the ends 9a and 9b owing to the capillary force in the front face 7 of the cathode porous body 9 is removed using the air 12. As a result, the humidity of the membrane electrode assembly 6 can be lowered via the cathode porous body 9. In other words, the temperature is controlled depending on the amount of the air 12 supplied for cooling while the humidity is maintained within a predetermined range owing to the capillary force of the porous body without changing the amount of air flowing into the membrane electrode assembly 6. Hence, the humidity and the temperature can be controlled using the single air supply apparatus 11. In the case that ambient air is used as the air 12 to be supplied, the moisture content thereof may be different depending on season, for example. In this case, a dehumidifying agent may be inserted between the air supply apparatus 11 and the membrane electrode assembly 6. For example, silica gel can be used as a dehumidifying agent. Even if no dehumidifying agent is used, the amount of the air 12 supplied from the air supply apparatus 11 to the ends 9a and 9b may be changed using a humidity indicator. To change the amount of the air 12 supplied from the air supply apparatus 11 to the ends 9a and 9b, an air supply valve 35 shown in FIG. 8 and described later may be used for the adjustment.

### [Functions of the Fuel Cell]

Next, the basic functions of the power generating stack shown in FIG. 1 will be described also referring to FIG. 8. The functions are described herein, in the case that an aqueous methanol solution serving as fuel is supplied from the anode passage plate 10 through the anode gas diffusion layer 4 to the anode catalyst layer 2 and that the air 12 is supplied from the air supply apparatus 11 to the cathode catalyst layer 3.

First, the aqueous methanol solution is supplied from a fuel mixture tank 33 to the anode passage plate 10 using a fuel mixture supply pump 34 or the like. The aqueous methanol solution flows into the fuel passage 15 through the anode gas diffusion layer 4 to the anode catalyst layer 2. In the anode catalyst layer 2 of the membrane electrode assembly 6, the anode reaction represented by Formula 2 takes place.

CH₃OH+H₂O→6H⁺+6e⁻+CO₂ (Formula 2)

On the basis of Formula 2, the protons (H⁺) produced in the anode catalyst layer 2 flow from the anode catalyst layer 2 through the electrolyte membrane 1 to the cathode catalyst layer 3. The electrons (e⁻) are transferred to the cathode catalyst layer 3 via the anode gas diffusion layer 4, an anode collection plate 21a, the external circuit (not shown), the cathode collection plate 21b, the cathode porous body 9 and the cathode gas diffusion layer 5. The carbon dioxide (CO₂) produced in the anode catalyst layer 2 flows through the anode gas diffusion layer 4 and the anode passage 15 and is discharged to the outside.

The protons and the electrons are used for the cathode reaction represented by Formula 3 in the cathode catalyst layer 3 using the air 12 supplied from the air supply apparatus 11. In FIG. 1, the air 12 flows through the passages 16a and 16b between the cathode porous body 9 and the cathode gas diffusion layer 5 and is supplied to the cathode gas diffusion layer 5.

4H⁺+4e⁻+O₂→2H₂O (Formula 3)

Generally, when the cathode reaction (Formula 3) takes place, the protons are transferred, and methanol (CH₃OH) and water (H₂O) flow through the electrolyte membrane 1 and are also transferred. In this way, the methanol having passed through the electrolyte membrane 1 causes an oxidation reaction represented by Formula 4 in the cathode catalyst layer 3 using the air 12 supplied from the air supply apparatus 11, and water is produced.

CH₃OH+3/2.O₂→CO₂+2H₂O (Formula 4)

The water that is produced according to the cathode reaction (Formula 3) and part of the water having passed through are reversely diffused to the anode catalyst layer 2 through the electrolyte membrane 1. The remaining water is transferred from the membrane electrode assembly 6 through the front face 7 of the cathode porous body 9 to the outside.

It is herein assumed that the cathode catalyst layer 3 and the cathode gas diffusion layer 5 having much effect on the air supply in the cathode reaction form a single system (hereafter referred to as “system X”). To evaluate the mass balance (mol/s) of the water per unit time in this system X, the following amounts A to E are defined as described below. These are all amounts per unit time. It is assumed that the amount of the water that directly vaporizes from the system X is ignorable in comparison with the amounts A to E.

A=the amount of the water transferred from the system X through the cathode porous body 9 to the outside
=Qc (the flow amount of the cooling air of the fan)×Area (the area of the porous body making contact with the air of the fan)×γ(coefficient)

B=the amount of the water transferred from the system X, that is, from the anode catalyst layer 2 through the electrolyte membrane 1 to the cathode catalyst layer 3

C=the amount of the water produced in the system X according to the cathode reaction (Formula 3)

D=the amount of the water produced in the system X according to the oxidation reaction (Formula 4) of methanol

Hence, the balance of the water in the membrane electrode assembly 6 can be evaluated according to the following amounts F and G.

E=the decreased amount of the water per unit time in the system X=(A)

F=the increased amount of the water per unit time in the system X=(B+C+D)

When E is equal to F, the balance of the water in the membrane electrode assembly 6 is maintained. On the other hand, when E is smaller than F, water is accumulated inside the system X of the membrane electrode assembly 6. If water is accumulated, air supply becomes insufficient in the region in which the water is accumulated. As a result, the output of the fuel cell lowers, and the power generation efficiency of the entire fuel cell lowers as described above.

Hence, in order to stably maintain high power generation efficiency, it is necessary to smoothly transfer water from the cathode catalyst layer 3 and the cathode gas diffusion layer of the membrane electrode assembly 6 so that E becomes larger than F and to suppress water from being accumulated in the system X. The flow amount of the air 12 required for cooling the power generating stack is larger than the flow amount of the air 12 that should be supplied according to the cathode reaction (Formula 3). At this time, the amount (=E) of the water that can be contained in the air 12 required for cooling the power generating stack can be made larger than F by making the area A of the cathode porous body 9 making contact with the fan larger than a predetermined value. With the embodiment, water discharge can be accelerated.

On the other hand, in the case that E is made extremely larger than F (E>>F), the electrolyte membrane 1 is dried and the power generation efficiency lowers. Even in this case, whiled is charging water, the cathode porous body 9 can accumulate part of the water inside the pores thereof. As a result, the drying can be suppressed. In other words, even in the case that the accumulation of the water inside the cathode porous body 9 is excessive or conversely even in the case that the accumulation of the water is reduced excessively and drying occurs, the cathode porous body 9 appropriately serves to maintain the state of the water contained inside the membrane electrode assembly 6.

### (Power Generating Stack Assembly)

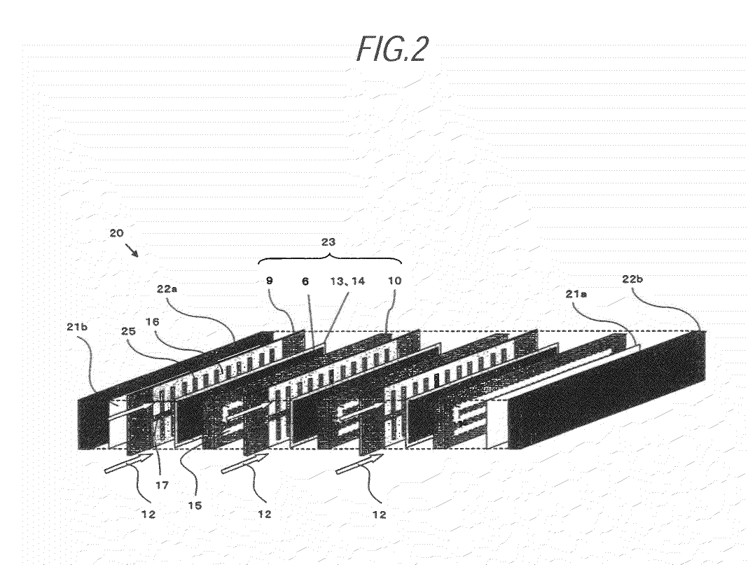

FIG. 2 is a conceptual perspective view showing the development of main components at the time when the power generating stack described above is stacked into multiple layers in series so as to be formed into a power generating stack assembly.

It is assumed that the power generating stack including the membrane electrode assembly 6, the cathode porous body 9, the anode passage plate 10 and the anode gaskets 13 and the cathode gaskets 14 for preventing the leakage of fuel and air is one cell element of a power generating stack assembly 20.

The collection plates 21a and 21b for collecting electricity from all the cell elements and clamping plates 22a and 22b for securing and clamping the cell elements are provided at the ends of the power generating stack assembly 20.

Furthermore, the air supply apparatus 11 is also provided (not shown) as in the case of FIG. 1, and air (12a to 12c) is supplied to the cathode porous body 9 in the longitudinal direction thereof.

### (Cathode Porous Body)

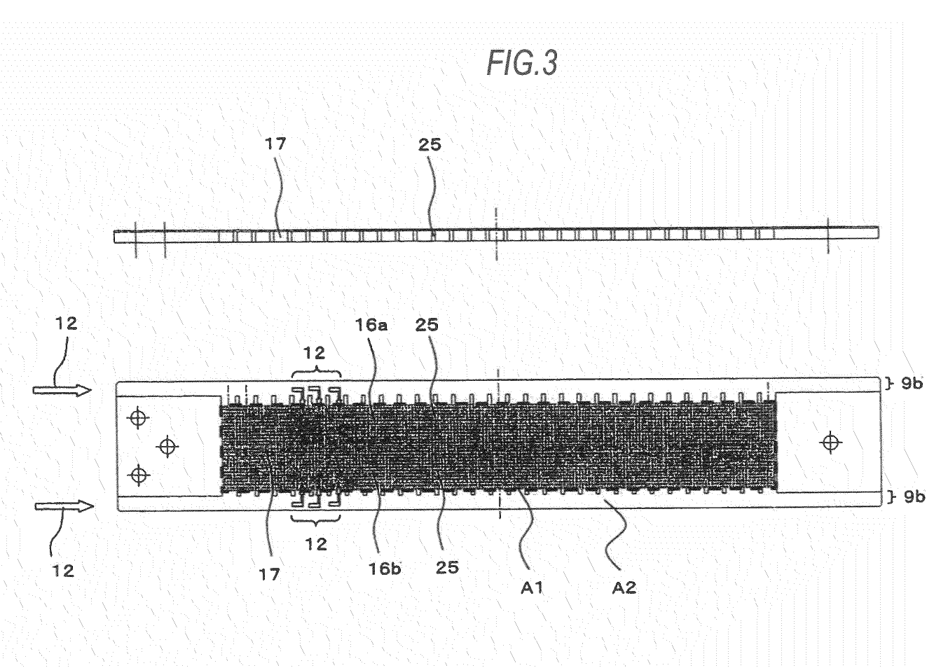

FIG. 3A is a detailed top view showing the cathode porous body 9 shown in FIG. 2, and FIG. 3B is a detailed front view showing the cathode porous body 9 shown in FIG. 2. The cathode porous body 9 includes a contact region A1 (the region enclosed by the broken lines in FIG. 3B) making contact with the membrane electrode assembly 6 and a water discharging region A2 around the circumference thereof. On the face of the cathode porous body 9 making contact with the membrane electrode assembly 6, the concave passages 16a and 16b for supplying the air 12 to the membrane electrode assembly 6 are separated by a passage wall 25. Furthermore, the convex passage partition 17 is formed at the center of the membrane electrode assembly 6 to separate the passage into the passages 16a and 16b such that the passages 16a and 16b do not communicate with each other.

The air 12 is supplied from the air supply apparatus 11 to the upper and lower faces of the water discharging region A2 of the cathode porous body 9. The air 12 is dispersed through the passages 16a and 16b and is taken into the contact region A1 making contact with the membrane electrode assembly 6.

The water discharging region A2 has the ends 9a and 9b protruding from the contour of the membrane electrode assembly 6, that is, from the contact region A1, so that the air 12 supplied from the air supply apparatus 11 makes contact therewith efficiently. In the case that it is assumed that the hydrophilicity of the cathode porous body 9 is determined such that the relationship of (the hydrophilicity in A2)>(the hydrophilicity in A1 is established, the water in the contact region A1 can be transferred to the discharging region A2 efficiently. The above-mentioned method can be used to change the hydrophilicity.

### Second Embodiment

A second embodiment of the present invention will be described below referring to the drawings.

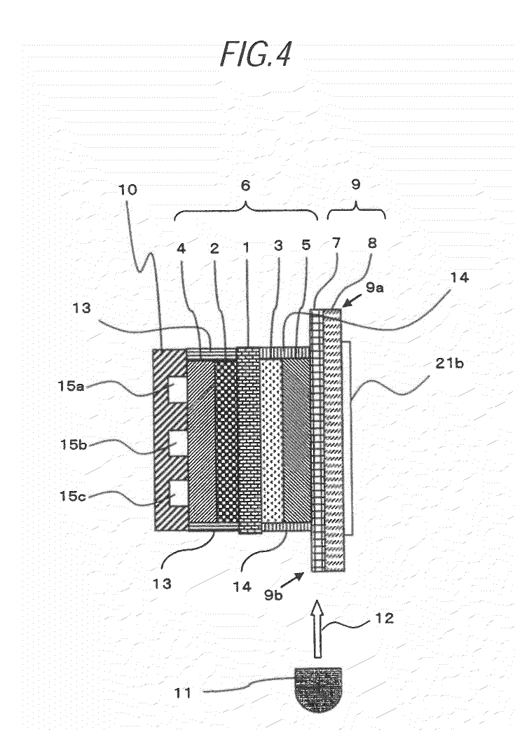

FIG. 4 shows the configuration of one cell element of a power generating stack assembly according to the second embodiment. The one cell element includes a membrane electrode assembly 6, an anode passage plate 10, a cathode porous body 9, a cathode collection plate 21b, and anode gaskets 13 and cathode gaskets 14 for preventing the leakage of fuel and air. The same configurations, actions and effects as those of the first embodiment are not described, and mainly the differences are described.

Unlike to the first embodiment, the entire face of the membrane electrode assembly 6 makes contact with the cathode porous body 9. In other words, the membrane electrode assembly 6 is configured so as not to have the passages 16a and 16b, the partition 17 and the passage wall 25.

Hence, the ends 9a and 9b of the cathode porous body 9 protruding from the contour of the membrane electrode assembly 6 are exposed to the air 12 supplied from the air supply apparatus 11, and water can be vaporized only therefrom.

There is a tradeoff relationship between raising the porosity of the cathode porous body 9 to enhance the permeability of water and air and ensuring the mechanical strength and shape processability of the power generating stack. Hence, in the first embodiment, the capability of supplying the air 12 is ensured by forming and providing the passages 16a and 16b for taking in the air 12 separately inside the porous body, the mechanical strength of which is ensured.

On the other hand, in this embodiment, roles are shared between the cathode porous body 9 and the cathode collection plate 21b; in other words, the supply of the air 12 is attained using the cathode porous body 9 having high porosity, and the ensuring of the mechanical strength of the power generating stack is attained using the cathode collection plate 21b. As a result, the specifications for attaining the actions and purposes of the two members can be ensured easily. Smooth water discharge and air supply can be attained by forming the cathode porous body 9 using a thin material having high air permeability as in the case of the cathode gas diffusion layer 5.

The passages 16a and 16b are not required to be provided separately by using the cathode porous body 9 having high porosity as described above, whereby the production steps and cost can be reduced. In the case that the air 12 is supplied to the membrane electrode assembly 6 by diffusing part of the air 12 supplied from the air supply apparatus 11 into the cathode porous body 9, the take-in width (take-in area) of the air 12 increases as the width of the cathode porous body 9 increases, whereby the diffused amount of the air 12 increases. Hence, the diffused amount of the air is increased and high load operation can be carried out by adjusting the depth of the cathode porous body 9, the front face of which is subjected to hydrophilizing processing, for example, by stacking the cathode porous body 9 into multiple layers. In this configuration, the water discharge capability can be enhanced by raising the hydrophilicity of the cathode porous body 9 at the ends 9a and 9b so as to be higher than that at a portion of the front face 7 making contact with the membrane electrode assembly 6. That is, the cathode porous body 9 has a contacting surface where the cathode porous body 9 is in contact with the membrane electrode assembly 6, and the cathode porous body 9 is formed so that the ends 9a and 9b thereof has the hydrophilicity higher than that of the contacting surface thereof.

### EFFECT

With this embodiment, since the cathode porous body 9 does not have the passages 16a and 16b, water is prevented from stagnating inside the spaces of the passages 16a and 16b. In addition, even in the case that water is removed excessively from the cathode, since the porosity inside the cathode porous body 9 is high, the internal volume thereof capable of containing moisture is large. As a result, the cathode porous body 9 prevents the membrane electrode assembly 6 from being dried excessively, and further miniaturization and higher mechanical strength of the power generating stack can be ensured.

### Third Embodiment

A third embodiment of the present invention will be described below referring to the drawings.

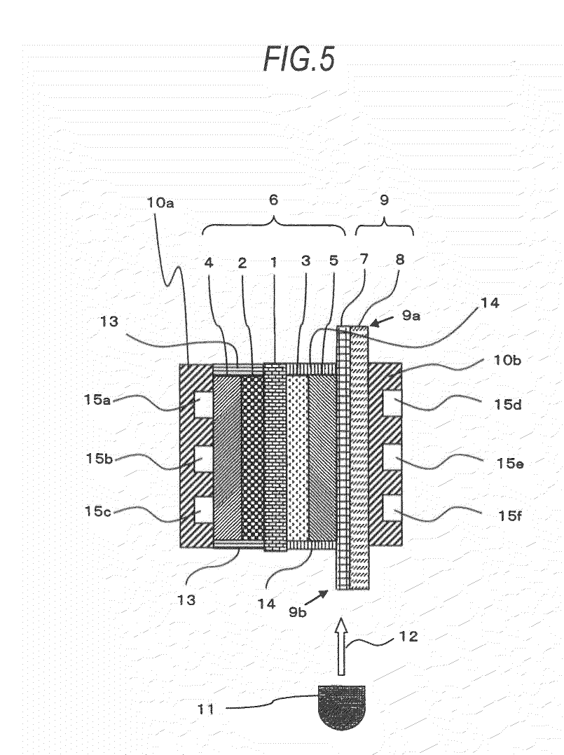

FIG. 5 shows the configuration of one cell element of a power generating stack assembly according to the third embodiment.

In this embodiment, when the power generating stack is stacked into multiple layers, an anode passage plate 10b adjacent to a cathode collection plate 21b is provided with the function of the cathode collection plate 21b and is integrated therewith so that the anode passage plates 10b is used as the cathode collection plate 21b to attain further miniaturization. The one cell element includes a membrane electrode assembly 6, anode passage plates 10a and 10b, a cathode porous body 9 and anode gaskets 13 and cathode gaskets 14 for preventing the leakage of fuel and air. The same configurations, actions and effects as those of the first and second embodiments are not described, and mainly the differences are described.

The face of the anode passage plate 10b, on the opposite side of the face making contact with the anode gas diffusion layer 4 of the membrane electrode assembly 6, makes contact with the cathode porous body 9. Hence, the anode passage plate 10b is used to collect electricity from the anode passage plate 10a of the membrane electrode assembly 6 and from the cathode. In this case, since the anode passage plate 10b also serves as the cathode collection plate 21b, further miniaturization of the power generating stack is made possible. The portion of the anode passage plate 10b serving as the cathode collection plate 21b can be formed of a titanium plate, for example. In addition to the titanium plate, a high-density carbon plate, a stainless steel plate, etc. having electric conductivity and mechanical strength can also be used.

### Fourth Embodiment

A fourth embodiment of the present invention will be described below referring to the drawings.

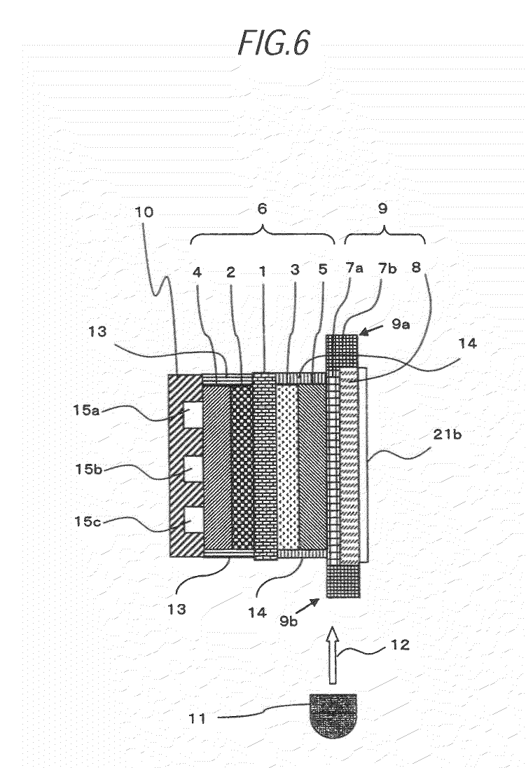

FIG. 6 shows the configuration of one cell element of a power generating stack assembly according to the fourth embodiment. The one cell element includes a membrane electrode assembly 6, an anode passage plate 10, a cathode porous body 9 and anode gaskets 13 and cathode gaskets 14 for preventing the leakage of fuel and air. The same configurations, actions and effects as those of the first and second embodiments are not described, and mainly the differences are described.

This embodiment is related to the second embodiment and is characterized in that a front face 7b (second front face portion) having a characteristic different from that of a front face 7a (first front face portion) making contact with the membrane electrode assembly 6 is provided at the ends 9a and 9b of the cathode porous body 9.

The front face 7a making contact with the membrane electrode assembly 6 is mainly intended to smoothly absorb and transfer water. However, the ends 9a and 9b are required to smoothly vaporize water and expected to discharge water rather than to absorb water. To attain these actions and purposes, the front face 7b different from the front face 7a of the cathode porous body 9 can be used. With this configuration, the separate portions, that is, the front faces 7a and 7b, can be provided with different functions using one starting material. Since smooth vaporization is performed at the front face 7b, water absorption and transfer at the front face 7a can be accelerated.

The specific surface area of the front face 7b is made larger than that of the front face 7a, for example. This is made possible, for example, by integrally forming the front face 7a and the front face 7b by press working such that different densities are provided for the front face 7a and the front face 7b.

### Fifth Embodiment

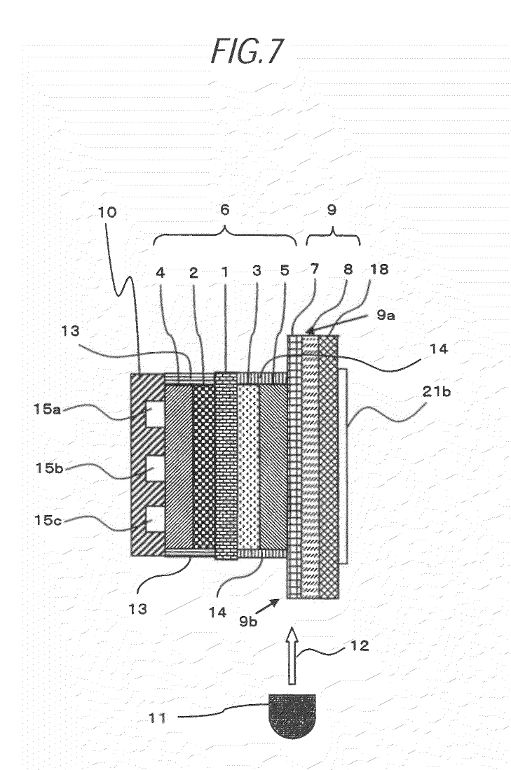

A fifth embodiment of the present invention will be described below referring to the drawings. FIG. 7 shows the configuration of one cell element of a power generating stack assembly according to the fifth embodiment.

In this embodiment, a filter 18 is provided between the cathode porous body 9 and the cathode collection plate 21b. This filter 18 absorbs hazardous substances, such as formaldehyde, formic acid, unreacted methanol, etc. produced by chemical reactions other than those represented by Formula 3 and Formula 4. As the filter 18, for example, activated carbon can be used. The cathode porous body 9 has a hydrophilized layer merely on the front face 7 thereof. Water passes through this hydrophilized front face 7 and is discharged to the ends 9a and 9b. Hence, the droplets generated in the cathode catalyst layer 3 according to the chemical reactions (Formula 3 and Formula 4) do not attach to the filter 18. As a result, the efficiency of removing hazardous substances in the filter 18 can be suppressed from lowering.

In addition, the water produced inside the filter 18 can be discharged using the air 12 flowing into the cathode porous body 9. Since the filter 18 is provided in each cell element of the power generating stack assembly 20, the operating temperature thereof can be raised, and the hazardous substance processing efficiency can be raised. The filter 18 is not required to be separated from the cathode porous body 9 but may be incorporated inside the cathode porous body 9 and integrated.

### Sixth Embodiment

A sixth embodiment of the present invention will be described below referring to the drawings.

FIG. 8 shows the configuration of a fuel cell system according to the sixth embodiment. Numeral 11 designates an air supply apparatus, numeral 20 designates a power generating stack assembly, numeral 31 designates a raw fuel tank, numeral 32 designates a raw fuel supply pump, numeral 33 designates a fuel mixture tank, numeral 34 designates a mixture fuel supply tank, numeral 35 designates an air supply side valve, numeral 36 designates an air discharge side valve, numeral 37 designates a controller, numeral 41 designates a fuel tank measuring device, numeral 42 designates a mixture tank measuring device, and numeral 43 designates a power generating stack measuring device. Although a fuel-circulating type fuel cell system is shown in FIG. 8, the present invention is not limited to this embodiment.

Fuel containing concentrated methanol is accommodated in the raw fuel tank 31. The raw fuel supply pump 32 supplies the concentrated methanol from the raw fuel tank 31 to the fuel mixture tank 33 via pipes L1 and L2. The raw fuel tank 31 is provided with the fuel tank measuring device 41. The fuel tank measuring device 41 monitors the amount and temperature of the liquid in the raw fuel tank 31 and transmits the measured values to the controller 37 via a signal line S1. A liquid meter can be used to monitor the amount of the liquid, and a thermocouple can be used to monitor the temperature. When the liquid amount lowers to a predetermined value or less, the controller 37 issues a warning. The warning is indicated on a monitor (not shown) to inform the user of the power generating stack assembly 20 that the raw fuel remains slightly.

In the fuel mixture tank 33, the concentrated methanol is diluted with the water recovered from the power generating stack assembly 20 via a pipe L5, and a low-concentration aqueous methanol solution is obtained. The concentration of the low-concentration aqueous methanol solution is determined depending on the operation conditions of the power generating stack assembly 20. The concentration of the low-concentration aqueous methanol solution accommodated in the fuel mixture tank 33 is monitored using the mixture tank measuring device 42, and the measured value is transmitted to the controller 37 via a signal line S3. When the concentration of the low-concentration aqueous methanol solution is lower than a predetermined value, a signal for instructing to drive the raw fuel supply pump 32 is transmitted from the controller 37 to the raw fuel supply pump 32 via a signal line S2, and operation is carried out to supply the concentrated methanol from the raw fuel tank 31. When the predetermined concentration is reached, a signal instructing to stop or decelerate the raw fuel supply pump 32 is transmitted via the signal line S2.

The mixture fuel supply tank 34 supplies the low-concentration aqueous methanol solution adjusted to have the predetermined concentration from the fuel mixture tank 33 to the power generating stack assembly 20 via pipes L3 and L4. Required output conditions and other conditions are input from the outside (not shown) or from the various measuring devices (41, 42 and 43) inside the fuel cell system to the controller 37. On the basis of the information, signals for carrying out various operations for driving, stopping, accelerating and decelerating the mixture fuel supply tank 34 are transmitted from the controller 37 via a signal line S4.

The low-concentration aqueous methanol solution is supplied to the anode passages (for example, 15a, 15b and 15c shown in FIG. 1) of the power generating stack assembly 20 as described above. The temperature and electrical output of the power generating stack assembly 20 are monitored using the power generating stack measuring device 43, and the obtained information is transmitted to the controller 37 via a signal line S6.

The air 12 is supplied from the air supply apparatus 11 to the power generating stack assembly 20 via a pipe L1, the air supply side valve 35 and a pipe L12. Part of the air 12 is supplied to the cathode passages (for example, 16a and 16b in FIG. 1) to accelerate the cathode reaction (Formula 3), and the remaining of the air 12 is supplied so as to make contact with the ends 9a and 9b of the cathode porous body 9 and is used to vaporize the water having been transferred to the ends 9a and 9b.

The change in the temperature of the power generating stack assembly 20 is monitored using the power generating stack measuring device 43, and the obtained information is transmitted to the controller 37 via a signal line S6. When the temperature of the power generating stack assembly 20 becomes higher or lower than a predetermined value, the above-mentioned operation is carried out, whereby the temperature of the power generating stack assembly 20 is controlled on the basis of the signals from the controller 37 so that the power generation efficiency is maintained within an appropriate range.

The operation and control of the fuel cell system will be described more specifically as follows.

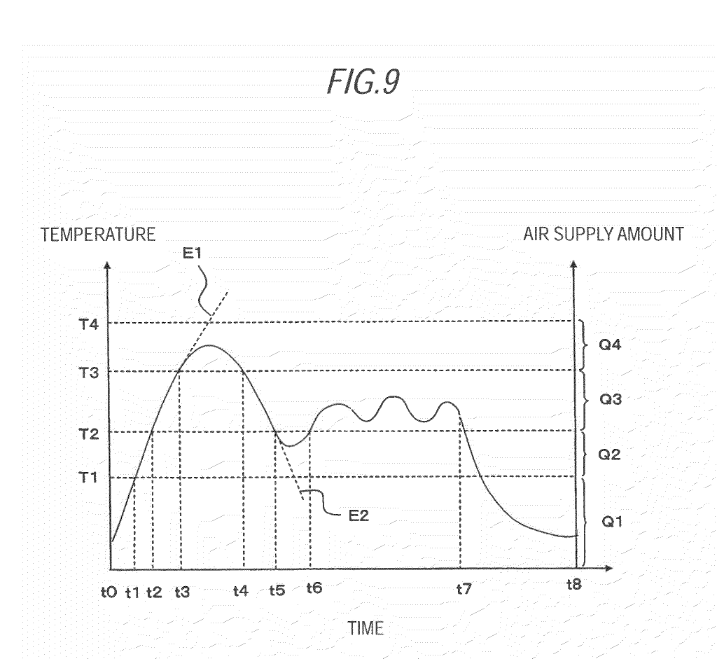

For example, as shown in FIG. 9, the operation in which the power generating stack assembly 20 is started at time t0 and stopped at time t7 and then completely stopped at time t8 is described below.

First, the power generating stack assembly 20 is started at time to by inputting a start signal to the controller 37 from the outside. The signal may be input to the controller 37 manually as a matter of course.

On receiving this start instruction, the air 12 is supplied from the air supply apparatus 11 to the power generating stack assembly 20. The air supply amount at this time is assumed to be Q1. In the case that the air supply apparatus 11 is a fan, an instruction is issued to raise the rotation speed of its motor so that the air supply amount reaches Q1.

The power generating stack assembly 20 is heated using a heater (not shown). However, instead of using the heater, it may also be possible that fuel is supplied to the power generating stack assembly 20 and the fuel crossover occurring at this time is used for heating.

The temperature of the power generating stack assembly 20 is monitored using the power generating stack measuring device 43, and a signal is transmitted to the controller 37 via the signal line S6. This signal is analyzed using the controller 37. The result of the analysis is used to control the controllable components of the fuel cell system, that is, the raw fuel supply pump 32, the mixture fuel supply tank 34, the air supply side valve 35, the air supply apparatus 11 and the air discharge side valve 36, via the signal lines S2, S4, S5, S7, S8 and S9.

When the temperature of the power generating stack assembly 20 becomes higher than first preset temperature T1 at time t, the air supply amount is changed from the first preset air supply amount Q1 to a second preset air supply amount Q2. Hence, electric power can be supplied to an outside load. The relationship between the rising of the temperature and the increase of the rotation speed at this time is stored in a data table in the controller 37 in advance before shipment. The control can thus be carried out referring to this data table.

In addition, the temperature of the power generating stack assembly 20 reaches second preset temperature T2 at time t2. At this time, the air supply amount is changed from the second preset air supply amount Q2 to a third preset air supply amount Q3. At this time, the stable steady state is assumed to be a state in which the temperature of the power generating stack assembly 20 is maintained in the range of T2 to T3.

Furthermore, when the temperature of the power generating stack assembly 20 reaches third preset temperature T3 owing to the fluctuations or the like of the outside load at time t3, the air supply amount is changed from the third preset air supply amount Q3 to fourth preset air supply amount Q4. As a result, vaporization from the ends 9a and 9b is accelerated, and the temperature of the power generating stack assembly 20 lowers.

When the temperature of the power generating stack assembly 20 becomes T3 or less at time t4, the air supply amount is further changed from Q3 to Q2.

When the temperature of the power generating stack assembly 20 becomes T2 or less at time t5, the air supply amount is further changed from Q2 to Q1. Hence, the temperature of the power generating stack assembly 20 turns to rise again.

The temperature of the power generating stack assembly 20 can be maintained stably between T2 and T3 by using the air supply amounts Q1 to Q4 obtained for each fuel cell system before shipment. An example of such a stable state is shown in FIG. 9 in the period between time t6 and time t7.

On receiving an instruction for stopping the power generating stack assembly 20 at time t7, the controller 37 stops supplying the fuel. As a result, the temperature of the power generating stack assembly 20 lowers gradually and finally becomes nearly equal to room temperature at time t8.

In the case that the temperature of the power generating stack assembly 20 rises further and becomes higher than fourth preset temperature T4 as indicated by the broken line E1 of FIG. 9 even when the air supply amount is changed from Q3 to Q4, or in the case that the temperature of the power generating stack assembly 20 lowers further and becomes lower than T1 as indicated by the broken line E2 even when the air supply amount is changed from Q3 to Q2, it is assumed that the fuel cell system has a problem, and the operation of the system is stopped.

Although the control in which the air supply amount is maintained constant is described above as an example, the temperature of the power generating stack assembly 20 and the rotation speed of the fan may be feedback controlled. Furthermore, it may also be possible to adopt a method for controlling the amount of the air 12 supplied to the power generating stack assembly 20 by opening/closing the air supply side valve 35 while the air supply amount of the air supply apparatus 11 is maintained constant.

It is herein assumed that the relationships of T1≦T2≦T3≦T4 and Q1≦Q2≦Q3≦Q4 are established.

The off gas generated during the cathode reaction (Formula 3) and the air 12 having been used for water vaporization are discharged from the power generating stack assembly 20 to the outside via a pipe 13, the air discharge side valve 36 and a pipe 14 as described above, whereby the temperature of the power generating stack assembly 20 is controlled.

The gas produced according to the anode reaction (Formula 2), unused fuel, etc. are recovered from the power generating stack assembly 20 into the fuel mixture tank 33 via the pipe L5.

The temperature of the power generating stack assembly 20 can be measured using a thermocouple installed on the surface of the power generating stack assembly 20, for example, on the clamping plate (22a or 22b). Instead of the thermocouple, a platinum resistor or the like can also be used as a temperature sensor. In the case that temperature sensors are disposed at multiple locations and the temperature is detected according to the integrated data from the temperature sensors, measurement errors can be reduced.

When the temperature of the power generating stack assembly 20 is T1 or less, the air supply amount is lowered to Q1 to shorten the time (starting time) until the temperature rises to the predetermined temperature range. At this time, when the air supply amount is lowered, the water discharged from the membrane electrode assembly 6 is reduced. As a result, air diffusion is inhibited, and the output may lower. However, since the cathode porous body 9 absorbs the water discharged from the membrane electrode assembly 6, the air diffusion is suppressed from lowering. As a result, the output is suppressed from lowering.

Furthermore, when the temperature of the power generating stack assembly 20 becomes T4 or more, the air supply amount is increased to Q4 to shorten the time until the temperature lowers to the predetermined temperature range. When the air supply amount is increased, the water discharged from the membrane electrode assembly 6 increases, whereby the output may lower owing to the drying of the membrane electrode assembly 6. However, since the water accumulated inside the cathode porous body 9 humidifies the incoming air, whereby water discharge from the membrane electrode assembly 6 can be suppressed. As a result, the output is suppressed from lowering.

In the cathode porous body 9 according to the first embodiment shown in FIG. 1, since the partition 17 is provided at the center, the increase itself in the amount of the incoming air owing to convection is suppressed. Hence, the output reduction owing to drying in the case that the air supply amount Q4 has been increased to Q4 can be further suppressed.

### (Storage)

In the case that the power generating stack assembly 20 is not operated but stored for a long time or at high temperature, the water inside the membrane electrode assembly 6 vaporizes gradually and the membrane electrode assembly 6 becomes dry. In this case, as described above, the transfer resistance of protons in the electrolyte membrane 1 increases, and the power generation efficiency of the entire fuel cell system lowers eventually. Furthermore, in the case that dust or the like enters the power generating stack assembly 20 during storage and attaches to the cathode porous body 9, there is a danger in which the hydrophilicity of the front face 7 subjected to hydrophilizing processing may lower.

In this situation, the drying of the membrane electrode assembly 6 in a short time at least owing to air flow can be prevented by shutting off the air flow between the membrane electrode assembly 6 and the outside while the operation of the power generating stack assembly 20 is stopped.

To solve the problem of the drying, in the fuel cell system according to the embodiment, at least one of the air supply side valve 35 and the air discharge side valve 36 is shut off while the operation of the power generating stack assembly 20 is stopped, whereby the air flow between the membrane electrode assembly 6 and the outside can be suppressed and the degree of drying of the membrane electrode assembly 6 can be reduced.

Either the air supply side valve 35 or the air discharge side valve 36 can be omitted to simplify the fuel cell system. In this case, the remaining valve (35 or 36) should be shut off while the operation is stopped.

### EXAMPLE

Next, examples of the present invention will be described.

### Example 1

In Example 1, one cell element of a power generating stack assembly having the configuration shown in FIG. 1 was made using the method described below.

The membrane electrode assembly was made according to the procedure described below.

First, after a Pt—Ru anode catalyst and a Pt cathode catalyst, these being commercially available, were mixed and stirred with a perfluorosulfonic acid resin solution (Nafion™ 5 wt % solution), water and ethylene glycol, and the obtained slurry was applied onto a PTFE sheet by spraying and then dried.

Next, the catalyzed sheet made as described above was joined to a commercially available electrolyte membrane at 125° C. and at a pressure of 100 kgf/cm² (9.8 MPa). After the joining, only the PTFE sheet was peeled off, and a catalyzed electrolyte membrane was made.

A high-density carbon layer was mounted on commercially available water repellent carbon paper impregnated with 30 wt % PTFE to form an anode gas diffusion layer. The high-density carbon layer is mainly formed of carbon fine powder (Vulcan-72R™) and PTFE.

After the above-mentioned carbon fine powder and PTFE were mixed at a weight ratio of 1 to 0.66 in water and the mixture solution was stirred for 30 minutes, and then isopropanol was dripped into the mixture solution. After the dripping, the mixture solution was stirred again for 5 minutes and sprayed onto the face of the carbon paper making contact with the catalyst layer using a spraying method. High-temperature processing was carried out for 1 hour at 100° C. and then for 30 minutes at 360° C. to form a gas diffusion layer provided with a high-density carbon layer.

Commercially available carbon cloth provided with a high-density carbon layer was used as the cathode gas diffusion layer.

The catalyzed solid polymer membrane, the anode gas diffusion layer with the high-density carbon layer and the cathode gas diffusion layer described above were joined at 125° C. and at a pressure of 50 kgf/cm² (4.9 MPa), and a membrane electrode assembly having outside dimensions of 8×80 mm was made.

A cathode porous body was made using porous carbon subjected to hydrophilizing processing and formed into the shape shown in FIG. 3 and having outside dimensions of 18×106 mm.

The anode passage plate was made by cutting commercially available high-density carbon so as to be formed into a passage having a serpentine shape.

After the components prepared as described above were assembled as shown in FIG. 1, temperature control was carried out so that the temperature of the obtained power generating stack became 60° C., and fuel having a methanol fuel concentration of 1.2 mol/L was supplied to generate electric power.

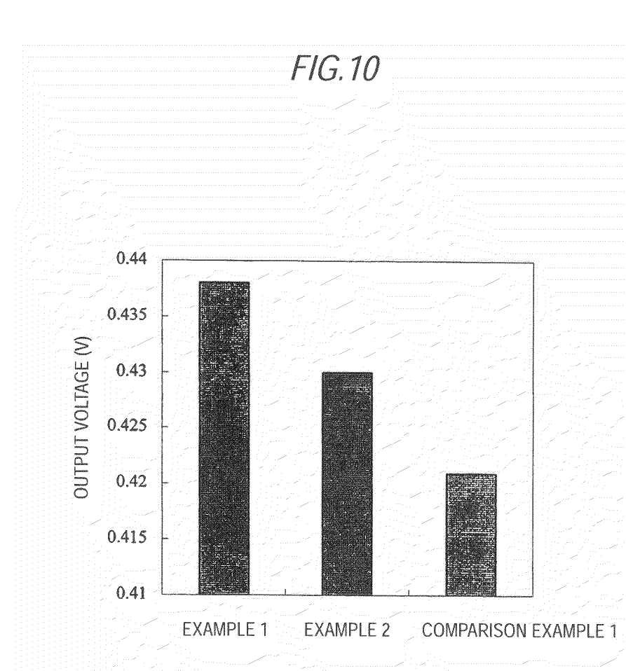

The voltage obtained as the result of the electric power generation is shown in FIG. 10.

### Example 2

A fuel cell was made in a way similar to that used for Example 1, except that the cathode porous body was made so as to have outside dimensions of 8×80 mm as in the case of the membrane electrode assembly, and the obtained fuel cell was used as Example 2. The voltage obtained as the result of the electric power generation is shown in FIG. 10.

### Comparison Example 1

A fuel cell was made in a way similar to that used for Example 1, except that a nonporous titanium plate having outside dimensions of 18×106 mm was used instead of the cathode porous body, and the obtained fuel cell was used as Comparison example 1.

The voltage value obtained at a constant load is shown in FIG. 10.

Referring to FIG. 10, the output voltage of Example 1 was 0.438 V, the output voltage of Example 2 was 0.430 V, and the output voltage of Comparison example 1 was 0.421 V. It was possible to obtain high voltages in Examples 1 and 2 in comparison with Comparison example 1. Furthermore, an effect of suppressing water from accumulating in the porous body was recognized in Example 1 in comparison with Example 2. The voltages obtained as the result of the electric power generation are shown in FIG. 10.

### Example 3

In this example, each cell element of the power generating stack assembly having the configuration shown in FIG. 4 was made using a method described below. The membrane electrode assembly and the anode passage plate thereof were similar to those of Example 1 described above.

Commercially available PTFE-untreated carbon paper was cut to form a cathode porous body having outside dimensions of 18×106 mm, and the cathode porous body was subjected to hydrophilizing processing.

The hydrophilizing processing was carried out by spraying the mixture slurry of hydrophilic carbon and hydrophilic polymer to PTFE-untreated carbon paper. A porous body having a thickness of 1.5 mm in average was herein used in Example 3.

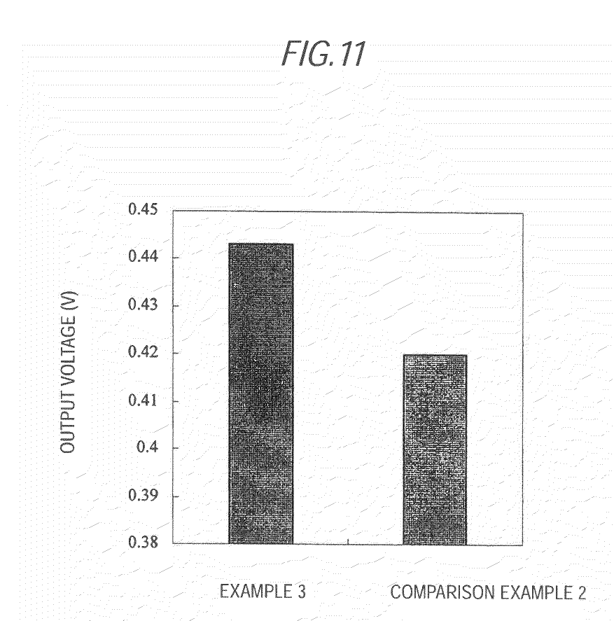

Electric power generation was carried out under the operation conditions that temperature control was performed so that the temperature of the stack became 60° C. and that fuel having a methanol fuel concentration of 1.2 mol/L was supplied. The voltage obtained as the result of the electric power generation is shown in FIG. 11.

### Comparison Example 2

As Comparison example 2, the power generating stack having the configuration shown in FIG. 4 was made in a way similar to that used for Example 3, except that carbon paper not subjected to hydrophilizing processing was used as the cathode porous body. The thickness of the cathode porous body was 1.5 mm in average, and the outside dimensions of the porous body were 18×106 mm as in the case of Example 3. The voltage obtained as the result of the electric power generation is shown in FIG. 11.

Referring to FIG. 11, the output voltage of Example 3 was 0.443 V and the output voltage of Comparison example 2 was 0.420 V. When the porous bodies having the same thickness were compared, the porous body subjected to hydrophilizing processing was able to obtain a voltage higher by 20 mV or more than that of the porous body not subjected to hydrophilizing processing. It was thus possible to confirm that the porous body subjected to hydrophilizing processing had an effect of suppressing output power reduction owing to the accumulation of water inside the membrane electrode assembly.

The present invention provides a fuel cell capable of controlling the humidity and temperature thereof easily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell comprising:
a membrane electrode assembly including:
an electrolyte membrane;
an anode catalyst layer disposed on one side of the electrolyte membrane;
a cathode catalyst layer disposed on the other side of the electrolyte membrane;
an anode gas diffusion layer disposed on the anode catalyst layer; and
a cathode gas diffusion layer disposed on the cathode catalyst layer;
a cathode porous body including a front face portion and a rear face portion, the cathode porous body being disposed on the cathode gas diffusion layer at the front face portion, the front face portion having an electric conductivity higher than that of air and having a hydrophilicity higher than that of the rear face portion;
an anode passage plate having a fuel passage and disposed on the anode gas diffusion layer; and
an air supply apparatus that supplies air toward an end of the cathode porous body.

2. The fuel cell according to claim 1,
wherein the cathode porous body is formed so that the end thereof protrudes beyond an outline of the membrane electrode assembly.

3. The fuel cell according to claim 1,
wherein the cathode porous body is formed of a material selected from the group consisting of:
a porous sintered metal; and
a porous carbon.

4. The fuel cell according to claim 1,
wherein the cathode porous body has an air passage formed so as to allow the air supplied from the air supply apparatus to pass therethrough.

5. The fuel cell according to claim 4,
wherein the air passage is formed so that, in an air-flowing direction, at least one portion is narrowed in a cross-sectional area than that at the other portion.

6. The fuel cell according to claim 1,
wherein the cathode porous body further includes a cathode collection plate disposed on the rear face portion.

7. The fuel cell according to claim 6,
wherein, when a plurality of the fuel cells are stacked, one of the anode passage plates and one of the cathode collection palates are formed in one piece so as to be shared by neighboring pair of the fuel cells.

8. The fuel cell according to claim 1,
wherein the front face portion of the cathode porous body includes:
a first front face portion in which the front face portion is in contact with the cathode gas diffusion layer; and
a second front face portion that is positioned in the end of the cathode porous body and that has a specific surface area higher than that of the first front face portion.

9. The fuel cell according to claim 1 further comprising:
a valve disposed on a down-stream of an air-flow generated by the air supply apparatus.

10. The fuel cell according to claim 1,
wherein the cathode porous body has a contacting surface that is in contact with the cathode gas diffusion layer, and
wherein, in the cathode porous body, a pore diameter at the contacting surface is larger than that at the end.

11. The fuel cell according to claim 1,
wherein the cathode porous body has a contacting surface that is in contact with the cathode gas diffusion layer, and
wherein, in the cathode porous body, a hydrophilicity at the end is larger than that at the contacting surface.

12. The fuel cell according to claim 1 further comprising:
a controller that controls the air supply apparatus to increase an air supply amount when a temperature of the membrane electrode assembly becomes higher than a predetermined temperature.

13. The fuel cell according to claim 1 further comprising:
a controller that controls the air supply apparatus to decrease an air supply amount when a temperature of the membrane electrode assembly becomes lower than a predetermined temperature.
